(19) United States
(12) Patent Application Publication
(10) Pub. No.: US 2007/0295713 A1
(43) Pub. Date: Dec. 27, 2007

(54) System and method for measuring core body temperature

(76) Inventor: John Carlton-Foss, Weston, MA (US)

Correspondence Address: KUTA INTELLECTUAL PROPERTY LAW, LLC, P.O. BOX 380808, CAMBRIDGE, MA, 02238, US

(21) Appl. No.: 11/453,506

(22) Filed: Jun. 15, 2006

(51) Int. Cl. H05B 1/02

(52) U.S. Cl. 219/497

(57) ABSTRACT

A layered thermometer for measuring core body temperature includes a plurality of layers. A first layer contacts the skin of a body being measured where the first layer includes a first sensor and a first insulating component, and optionally a protective layer contiguous with the skin. The first layer detects a first temperature substantially at the skin. A second layer is located contiguous to the first layer where the second layer includes a second sensor and a second insulating component. The second layer detects a second temperature substantially away from the skin. The values of the first temperature and the second temperature indicate the core temperature of the body. Alternative embodiments include a thermometer with three or more layers. Further alternative embodiments include analytic devices and devices statistical analysis.

### BACKGROUND

Measurement of core body temperature is an important part of determining the thermal state of living beings such as humans. In human anatomy, blood in the core moves up through the carotid artery to the hypothalamus where the body thermostat is located. The nervous system at the hypothalamus makes the determination to adjust the somatic thermal system for the body. If the body is overly warm or overly cold, the nervous system makes adjustments to cool off or warm up respectively. The adjustments typically involve increasing, decreasing, turning on, or shutting down various body functions. The nervous system uses core temperature to assess the extent to which the body should do this. Actions taken by the nervous system include such things as triggering sweating as the body heats, for example during exercise, and ceasing exercise when the core temperature rises too high. Other actions include such things as shivering or seeking exercise, shutting down circulation in the extremities, and shutting down non-essential organs when the body is too cold.

Conventional methods of measuring core body temperature include sublingual temperature measurement. Core body temperature can be measured by having a person place a conventional oral thermometer under his or her tongue. Sublingual thermometers are inexpensive and pervasive, but these thermometers are also cumbersome in environments where the subject person is active. Further, sublingual thermometers are typically a nuisance since they cannot be “worn.”

Alternatively, core body temperature can be conventionally measured through the rectum. Rectal temperatures are taken by inserting a thermal probe into the rectum of the person. Rectal temperature measurement is often viewed as intrusive, and many people find it offensive. Additionally, the thermal probe can be uncomfortable to wear while performing an activity. If the rectal temperature is to be recorded, or sent off-body through telemetry, then a wire must be typically be run from the rectum area of the subject to a recording device or radio.

Further alternatively, core body temperature can be conventionally measured through the esophagus. Esophageal temperature is taken by inserting a thermal probe in the esophagus. This method is also often found by subjects to be uncomfortable and intrusive.

Temporal measurement of core body temperature involves holding a device to the subject person's temple. The temporal temperature device measures the temperature of the blood in the artery that passes through the temple. The temperature in that artery is presumed to be substantially that of the body core. Temporal temperature measurement is difficult for a person to self-administer because the temporal artery is difficult to see. Accordingly, it is difficult for the person to place the thermal measurement device accurately at the artery. If the person is also attempting to perform an activity such as a physical training activity, temporal temperature measurement is even more difficult to administer. Temporal thermometers are typically small and hand-held but are also typically cumbersome and difficult for an active person to manage. Further, temporal thermometers generally cannot be taken by a participant into an event like a football or soccer game. Conventional temporal devices are not integratable with a helmet or other sporting gear to enable ongoing temperature measurement during the course of regular activity because of the exposed nature of the temperature measurement location, and the fragility of the device. Further, any support system for the device would typically move, resulting in some instability and this in turn could even result in physical risk for the user.

Conventional methods of taking core body temperature further include tympanic measurement. Tympanic measurement involves similar difficulties as those listed above for temporal measurement. In addition, the site of measurement is difficult to access and the method again includes risk of injury if the device shifts.

A common conventional method for taking core body temperature is a temperature pill. This method is used, for example, for measurement of core body temperature of a small number of athletes such as linemen on professional football teams during practices. The subject person swallows the pill some hours prior to activity so that the pill is located in the stomach or upper intestines at the time of exercise. The temperature pill includes a small thermocouple and transmitter contained within a capsule. The thermocouple measures the temperature and the radio transmitter broadcasts the temperature readings to a receiver outside the body. The receiver is integrated with a console that reports the core temperature as measured by the pill.

While the temperature pill is generally a more effective method of measuring core body temperature in an active person, this pill has some flaws. Temperature pills are typically rather large. Accordingly, many people have trouble swallowing them. The temperature pill is at times unreliable. Further, the temperature pill only transmits data. Therefore, the external receiver has no means for communicating back to the temperature pill whether data has been received and whether the received data is intelligible or useful. Further, the pills are expensive and not re-useable, so that only well funded activities can regularly use the pills. Even such organizations as National Football League teams use temperature pills for a small percentage of their players.

For the foregoing reasons, there is a need for a new device that measures core body temperature in an active person.

### SUMMARY

The present invention is directed to a system and method for measuring core body temperature with an externally placed thermometer array wherein the thermometer array includes a plurality of sensors configured to provide a plurality of thermal measurements that are used to determine core temperature.

The simplistic placement of a sensor on the surface of body skin is generally known to provide inaccurate measurements of core temperature. Establishing a temperature gradient in an external thermometer array, however, enables core temperature to be derived.

Accordingly, embodiments of the present invention include a temperature device for measuring core body temperature. The temperature device includes a first layer to contact skin of a body being measured. An alternative embodiment includes a layer typically a protective layer, between the temperature device and the skin. In a further alternative embodiment, the first layer is in direct contact with suitable clothing or other intermediate layer allowing heat transfer from the skin and generally limiting leakage to the environment. The first layer includes a first sensor and a first insulating component where the first layer to detect a first temperature substantially at the skin. The temperature device further includes a second layer located contiguous to the first layer where the second layer includes a second sensor and a second insulating component. The second layer to detect a second temperature substantially away from the skin. The values of temperatures in the temperature device indicate core temperature of the body. This temperature device, then, enables core body temperature to be measured externally, that is, entirely non-invasively.

Another embodiment of the invention is a thermometer for measuring core body temperature having a plurality of layers contiguously arranged, each layer including a sensor and an insulating component. A first layer of the plurality of layers is placed on the skin with the remaining plurality positioned at successive distances from the skin. The values of the temperatures of the layers indicate core body temperature.

Another embodiment of the invention is a system for determining core body temperature having a layered thermometer including a plurality of sensors, where each sensor is separated from neighboring sensors by layers of insulation. The system further includes an interface in communication with the layered thermometer. The system further includes an analytics device in communication with the layered thermometer through the interface wherein the analytics device derives a core body temperature from sensor data. Thus core body temperature can be measured quite accurately using an external thermometer.

Embodiments of the invention further include a method of an analytics device operating in a system for measuring core body temperature. The analytics device first accepts as input a plurality of temperature measurements where each measurement is taken from a different thermal layer with relation to a measured body. The analytics device then analyzes the plurality of temperature measurements. Finally, the analytics device produces a derived temperature value based on results of the analyzing step.

The present invention together with the above and other advantages may best be understood from the following detailed description of the embodiments of the invention illustrated in the drawings, wherein:

### DRAWINGS

FIG. 1 is a cross-sectional side-view diagram of the thermometer according to principles of the invention;

FIG. 2 is a bottom view diagram of the thermometer of FIG. 1;

FIG. 3 is a block diagram showing thermal layers used as a model suitable for use by the present invention;

FIG. 4 is a graph of temperature as a function of position in the layers shown in FIG. 3;

FIG. 5 is a block diagram of a temperature system according to principles of the invention;

FIG. 6 is a diagram of a person wearing a chest strap holding the thermometer according to one embodiment of the invention;

FIG. 7 is a diagram of a person wearing a vest holding the thermometer according to an alternative embodiment of the invention; and

FIG. 8 is a flow chart of the method of measuring core temperature using an external thermometer according to principles of the invention.

### DESCRIPTION

A thermometer for measuring core body temperature includes a plurality of sensors and thermal insulation in a layered configuration. The thermometer is applied externally to the body being measured. A first of the sensors measures temperature at the skin and at least one other sensor measures temperature away from the skin. The temperatures measured by the sensors provide data for a calculation of temperature internal to the body.

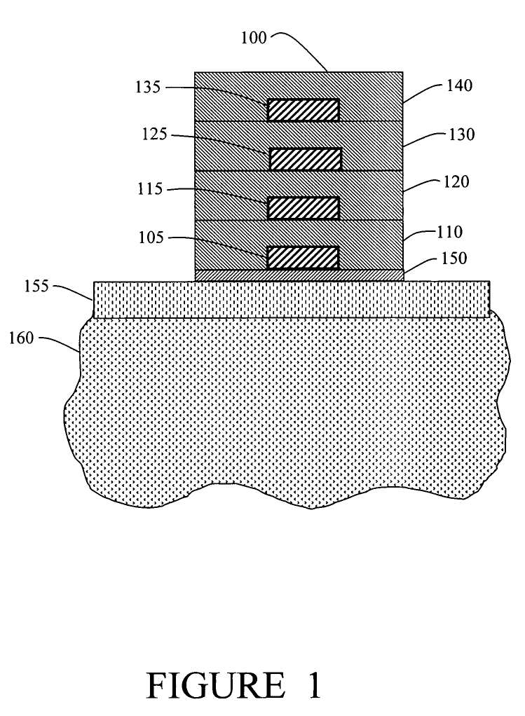

FIG. 1 is a cross-sectional side view diagram of a thermometer array according to one embodiment of the invention. The thermometer 100 includes a plurality of sensors 105, 115, 125, 135 and a plurality of insulation components 110, 120, 130, 140 arranged in layers. The temperature sensors 105, 115, 125, 135 are, for example, YSI (Yellow Springs Instruments, OH) 427 and 409AC thermistor probes. The insulation components 110, 120, 130, 140 are, for example, made of a thermal insulation material such as a plastic or a composite.

In operation, a first sensor 105 of the plurality of sensors, is placed in contact with the surface of the skin 155 of the body 160 to be measured. The thermometer 100 is made up of a “sandwich” or “telescope” of temperature sensors 105, 115, 125, 135 and layers of insulative material 110, 120, 130, 140 where the insulative material 110, 120, 130, 140 provides both thermal isolation of the sensors from the ambient environment 105, 115, 125, 135 and thermal thickness for thermal attenuation. The core temperature of the body 160 can be determined through extrapolation given temperature measurements from the sensors 105, 115, 125, 135.

Four layers of sensors and insulation components are shown in FIG. 1, however, the present invention is not limited to the configuration shown here. The present invention may include as few as two or three layers or more than four layers. In one alternative embodiment of the thermometer 100, the first layer consisting of the first sensor 105 and a first insulating component 110 is separated from the skin 155 by a thin protective component 150. The protective component 150 provides a protective layer for the thermometer 100 to protect the thermometer components from skin moisture and oils, for example. The protective component 150 provides little thermal insulation, however, it may be made of similar materials as the insulating components 110, 120, 130, 140 of the thermometer 100. The thicknesses of the various insulating components 110, 120, 130, 140 may be different within a thermometer array as well as in different thermometers. The analytics are able to include variations in the structure of the thermometer 100 in the determination of the core body temperature.

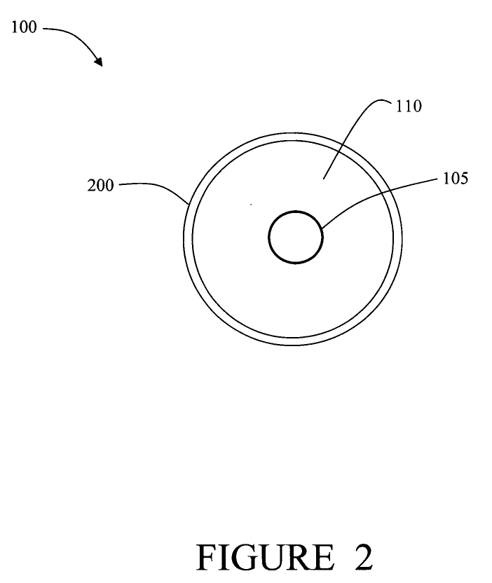

FIG. 2 is a bottom view of the thermometer 100 of FIG. 1 for measuring core body temperature. The first sensor 105 is contained within an insulation component 110 which together form a first layer of the thermometer 100 (shown in FIG. 1). The protective layer 150 is not included in this embodiment. Accordingly, a face of the first sensor 105 is exposed so that it may make contact with the skin. The insulating component 110 insulates the first sensor 105 from the surrounding environment and from the next thermometer layer as shown in FIG. 1. In addition, an outer coating 200 circumferentially covers the thermometer effectively sealing the layers against the environment surrounding the body being measured and the thermometer itself. In another arrangement, the outer coating also covers the top of the thermometer, that is, the side away from the body.

There are four elements that enable the external thermometer to operate in a core body temperature application. The thermometer array of the present invention encapsulates one or more temperature sensors so that they are embedded within a “sandwich” or “telescope.” This configuration has properties that enable the construction and use of an algorithm to extrapolate the core body temperature from the sensor temperature measurements in specified locations of the telescope.

A first element is the establishment of a strong coupling between the temperature sensor 105 and the skin 155 of the body 160 and a weak coupling of that same sensor 105 with the environment around the body 160. This is accomplished by the thermal insulation component 110 that surrounds the sensor 105 on all sides except the side of the sensor 105 that contacts the skin 155. The insulation component 110 has sufficient thickness at the sides of the sensor 105 so that there is substantially a negligible thermal contact with the environment around the thermometer 100. The edge areas are approximately 0.25 to 0.75 inches thick. The material composing the insulation component 110 has, in a first embodiment, a low thermal resistance between the thermal sensors, for example, an R-value equal to 1. This corresponding U-value is selected in order to provide thermal isolation from the environment even as the insulation component is used as a medium through which the temperature difference between the body and the environment can be attenuated. Examples of such materials are expanded semi-rigid rubber, or a neoprene blend with a nylon cover such as that used in knee supports for athletes. This material is impermeable to sweat and water so that there is evaporative cooling on the outside surface of the insulation but an absence of evaporative cooling from the immediate surface of the sensor array or the skin immediately underneath and in the immediate vicinity of the sensor array. In a preferred embodiment, the layers of the telescope are modularized with each sensor sitting in a small pocket of insulation that surrounds it on all but one side, this side being exposed to the previous layer and the layers fused together.

The protective layer 150 generally has a negligible insulative value. In one embodiment the protective layer 150 is not used. In another embodiment, the protective layer 150 would be present purely as a protective layer, separating the skin 155 from the first sensor 105.

The second element that enables the external thermometer is that of a thermal “sandwich” or “telescope” configuration. This is accomplished by successive layers of a temperature sensor encased in an insulative layer, then another temperature sensor encased in another insulative layer and so on. The layers can be iterated as many times as may be required to obtain more data points to make the application of the algorithm more accurate.

The third element is the blocking of the evaporation of sweat at the site on the skin 155 where the thermometer 100 is applied. Impermeability to moisture from the skin is accomplished by making the insulative thermometer housing 100 impermeable to sweat. This substantially eliminates the confounding effect of evaporation on the measurement of temperature in the region of the thermometer, by substantially eliminating the presence of sweat on the array surface, by making its effect predictable and measurable through calibration, or in ambient regimes conducive to profuse sweating, by the natural near-elimination of evaporative cooling on the array surface.

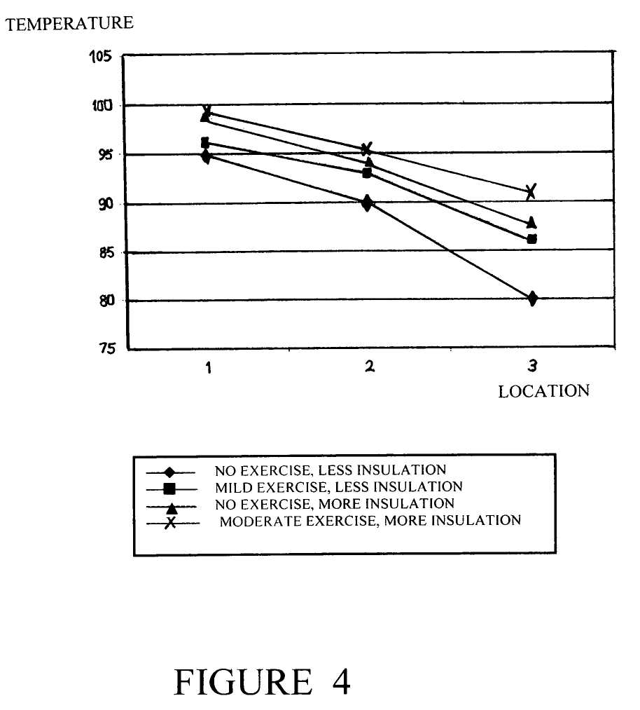

The fourth element is that of calibrating the thermometer. One example calibration point is an extreme case where a single thermal sensor is placed on the skin surface and surrounded by R-30 insulation, so that the single thermal sensor couples strongly to the body heat reservoir and very weakly to the ambient air reservoir. In this configuration, the thermometer measures temperatures that are effectively internal temperatures of the body. The surface skin has thickness including fatty layers and other characteristics that typically vary from one person to another. Thus the effective R-value of the skin typically varies from one person to another. The effective R-value of this skin layer can be calculated and factored into an algorithm or graph by measuring the temperatures at the layers of the thermal sensor telescope as well as the core temperature of the individual. The graph is of a type similar to that shown in FIG. 4, which is discussed below.

The thermometer device of the present invention is generally particularly accurate in certain regimes of interest. One such regime is that of humans such as athletes, functioning in environmental temperatures near the body temperature of 98.6° F. In contrast, the temperature difference between an exposed body part and arctic environments is likely to be large, leading to the need for large insulative layers to couple the temperature sensors to the body rather than to the environment. Such large insulative layers can include a mountaineering parka, with the thermometric device entirely on the body side of the parka and measuring core temperature. In an environment having an ambient temperature close to normal body temperature, the temperature difference is small, the slope of the graph of temperature versus position is essentially flat, leading to the requirement of a minimum amount of insulation to isolate the thermometric device. Thus, if the purpose of the thermometer device is to measure whether an active person is approaching a dangerously high core temperature, such as 101.5° F., at which one is at risk for the onset of heat exhaustion, the accuracy of the external core temperature measurement is readily sufficient, even with a very small device with minimal insulation.

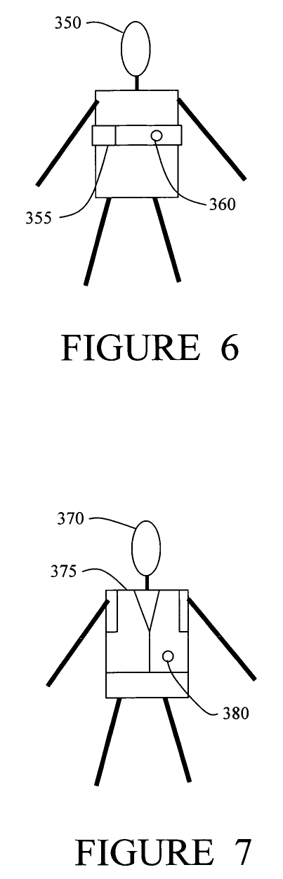

The thermometer 100 is held close to the skin 155 by an adhesive in a first embodiment. In a second embodiment, the thermometer 100 is held close to the skin 155 by embedding the thermometer 100 in a belt or strap, such as a chest strap or a shoulder strap as shown in FIG. 6. FIG. 6 shows a person 350 wearing a chest strap 355 holding a thermometer 360 according to one embodiment of the invention. The chest strap 355 holds the thermometer 360 in place even while the person 350 is active and enables temperature measurements to be taken in various settings including, for example, sporting events. In the embodiment in which a strap is used, layers of the strap can serve in some arrangements as the insulative layers of the thermometer sandwich. Alternatively, the thermometer 100 is embedded in a compression or other elastic shirt or garment such as the vest shown in FIG. 7. FIG. 7 shows a person 370 wearing a vest 375 holding a thermometer 380 according to principles of the invention.

In further alternative embodiments, the thermometer 100 is embedded subcutaneously. In the subcutaneous embodiment, the details of the temperature dynamics and the algorithm are appropriately altered to account for the differences in environment in this configuration. In this embodiment, the skin surface itself contains the thermometer as described herein, the tissue of the skin provides insulation and isolation, and the calibration and analysis properties of the thermometer are suitably modified.

### Telescopic Extrapolation of Temperature

A telescope of insulative layers in the thermometer is analogous to the layers of thermal insulation on a building. The successive insulative layers of a house may consist, for example, of clapboard, tar paper, sheathing, two-by-fours with glass fiber insulation in the air spaces, then vapor barrier and wallboarding. Each of the layers provides a separate insulative layer, attenuating the temperature difference between indoors and outdoors respectively. If the indoor temperature is, for example, 75° F. and the outdoor temperature is 35° F., then the temperature measured at any point in the wall is somewhere between 75° F. and 35° F. The temperature measurement varies as one moves inward or outward through the materials. If there is adequate insulation, the temperature throughout most of the structure is independent of whether there is some surface evaporative cooling on the outside wall. Further, the temperature varies approximately linearly as a proportion of the resistance value of the materials from the wall to a given point to the total insulative resistance value multiplied by the temperature difference and added to the beginning temperature. Knowledge of the temperature outdoors along with the shape of the resistance curve allows one to extrapolate the indoor temperature as a function of temperature measurements made outside the interior. If the wall were extended in certain locations consistent with the guidelines of the above teaching, and the thermometric array calibrated consistent with the insulation value of the wall, the same physics would still hold true, and it would be possible to extrapolate the indoor temperature of the house from information gathered entirely outside the house.

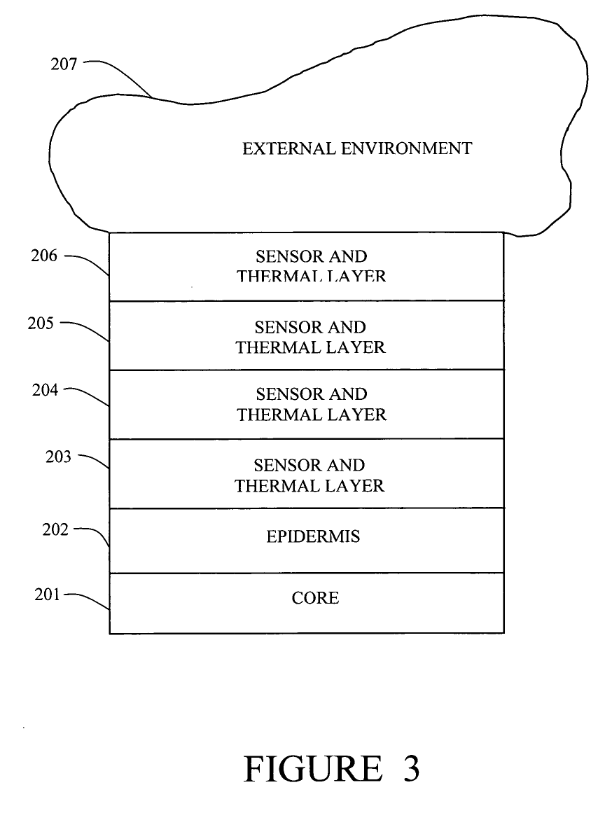

FIG. 3 is a diagram of successive insulative layers comprising the layers in a temperature measuring application. The layers are a model of the layers of a house or alternatively, layers of the human body. A core layer 201 is at a core temperature T₁. An epidermal layer 202 of insulative value R₂ is at an epidermal temperature T₂. A first exterior layer 203 of insulative value R₃ is at temperature T₃. A second exterior layer 204 of insulative value R₄ is at temperature T₄. A third exterior layer 205 of insulative value R₅ is at temperature T₅. A fourth exterior layer 206 of insulative value R₆ is at temperature T₆. The environment 207 is at temperature Tₑₙᵥ. The temperature at the nth layer is:

Tₙ=(T_{cnv}−T_{core})*(Rₙ/Rₜₒₜ) (1)

where

Rn=R₂+ . . . +Rₙ₋₁, and

Rtot=R₂+ . . . +R_{6.}

### Physiological Dynamics

FIG. 4 is a graph of temperature as a function of position in the layers of the thermal “sandwich” of the human body and a thermometer according to principles of the present invention. In this case thermometers were separated by thicknesses of wool and the entire configuration shielded from the ambient environment by a down jacket. Thus there could be no edge effects because the edges were effectively infinite in length and therefore in R-value. The graph shows data taken using a human subject operating at various degrees of activity and measured using various thermometer configurations.

The experimental subject in the experiments generating the data shown in FIG. 4 initially had a core body temperature of 95° F. measured sublingually. As a result of exercise during the course of the experimental procedure, the subject's core temperature, measured sublingually, rose to 99.3° F. Heat is typically generated in or near the body's core and diffuses outward through the thermal layers. This diffusion requires some time to occur. After the period of diffusion, the system reaches a new equilibrium. The experimental configuration in this experiment reached thermal equilibrium throughout the layers after about 2 minutes.

For greater/lesser increase in the internal rate of heat generation, the instantaneous temperature difference between the innermost layers and the outer layers is greater/lesser, so that diffusion is greater and slightly more/less time is required to reach equilibrium. For lesser insulation values for each of the layers, there is a decrease in the lag time before equilibrium, when the most accurate core temperature can be determined using this method. Prior to equilibrium, it is possible to measure core temperature externally or internally, but this measurement is not as accurate as when the measurement is performed after equilibrium is attained. Typically, a best time to measure rapid increases in core body temperature is prior to equilibrium, because the first derivative of temperature with respect to time is a measure of the differential between core temperature and the known initial temperature at the measurement point.

Returning to FIG. 4, the graph shows four lines, each line showing different experimental conditions. In a first set of experiments, the subject was at rest, that is, there was no exercise and the thermometer had few insulative layers. In a second set of experiments, the subject was mildly active and the same thermometer configuration as the first experimental configuration was used. In a third set of experiments, the subject was at rest but the thermometer had more insulative layers than in the first or the second experiments. In a fourth set of experiments, the subject was moderately active and the same experimental configuration as the third set of experiments was used.

For each activity regime and set of layers for the temperature measurement, there is a temperature measurement. In each case, the measured temperature rises along a smooth curve as predicted from the temperature at the outermost layer (which is closer to the core body temperature than the reading of the environmental temperature because there is a layer of insulation between the environment and the first temperature sensor so that the sensor is coupled somewhat more to the body temperature and somewhat less to the ambient temperature) to the core body temperature. As the ambient temperature through the various layers increases toward the core body temperature, the curve flattens. When the environmental temperature and the core body temperature are the same, the slope of the curves is zero. Obviously then, it is for environmental temperatures in the upper 90s ° F. and lower 100s ° F. that the method most readily provides accurate temperatures for either active or inactive people. When the environmental temperature is greater than the core body temperature, the slope of the curve becomes positive, indicating that the thermal layers are insulating the body against the heat. Again it is worth emphasizing that each of these curves is continuous, analytic and can be extrapolated to fill in any single missing data point, no matter where that point may be in the geometry of the configuration. Further the set of curves provides a continuously varying set for which any one member can be interpolated in relation to other curves immediately above it or below it on the graph.

Equation (1) predicts the temperature curves, and conversely, either equation (1) or the temperature curves can be used as the means to extrapolate the core body temperature given the temperatures at T_{R1} and T_{R2}.

### Enablement of Statistical Classification

Statistical learning techniques can also be used to “phase lock” the incoming data stream and to interpret the pattern of temperatures at the various layers of the sandwich. Statistical learning techniques are particularly useful for interpreting the pre-equilibrium data from the temperature sensors in the inventive device.

The datastream from the individual thermometers includes time varying values received by the controller and classifier engine as a result of various factors: including system noise, small variances in the thermometers and electronic components, temporary malfunction, physical or other shocks to the system. In one embodiment of the system the datastream values are fed through a classifier in order to “phase lock” the system so that such momentary variances are smoothed out to produce a continuous curve. A classifier is a predictive model that predicts an output value based on input data appropriate to the model. Throughout this discussion the general term “model” or “model/classifier” is used herein to describe any type of signal processing or analysis, statistical modeling, regression, classification technique, or other form of automated real-time signal interpretation. If a variance persists as indicative of such as equipment failure, then the curve deflects from its otherwise normal path and a readily recognized alert is switched on. In another embodiment, the classifier(s) used in determining a core temperature from the array temperatures are trained on noisy data so that variations in the input datastream are a normal part of the data analysis and do not confuse or lead to an abortion of the process.

Because the layered sensors enable the extrapolation of core body temperature and also provide differentials with respect to space and time, statistical learning techniques can be applied to rich data. For example, a Bayesian classifier can learn patterns of interest in the temperatures and differentials, and predict likely future troubles with core body temperature, while at the same time providing a probability that these troubles will occur. The following example is provided to illustrate the present invention using Bayesian classifiers. Other types of classifier are considered to be within the scope of the invention. The present invention is applicable in other situations.

In one case, that of linemen of professional football teams, there is iterated extreme exertion for five to fifteen seconds followed by a rest period for twenty to thirty seconds. Thus the core body temperature sensor will seldom be in equilibrium during the course of a practice or game. The pattern of temperature values, however, at the various layers can be learned by the classifier. There will be temperature sequences that will be benign, and other temperature sequences that will signal likely overheating. These can be captured using sample training data for insertion into a model for a statistical classifier. As one example of such a machine learning scenario, if the lineman's core body temperature is 100.5° F. and the lineman exerts himself more excessively during a hurry-up offense with shorter breaks, on the order of 0-10 seconds, then the temperatures in the inner layers will increase more rapidly than those in the outer layers, and also will increase differentially in comparison to the increase when there is less exertion or a longer rest period between exertions. Sequences such as this that lead to troubles, and sequences that do not lead to troubles, can be identified experimentally by instrumenting lineman while they perform their normal, or artificially constructed, activities. A Bayesian classifier, for example, can learn from individual linemen's profiles, or from learning samples of linemen's profiles, the patterns for the individual or a class of linemen that will lead to high risk of heat exhaustion versus little risk of heat exhaustion. While the learning time for creating a model for such classifiers can be substantial, the operation time to apply the model can be quite short. Thus, in substantially real time, the coaches and trainers on the sideline can know whether a particular player is at significantly increasing risk of heat exhaustion (and also resulting performance decrement) before his core temperature reaches 101.5° F. Knowing in advance can enable substitution patterns during the play of the game that reduces risk and gives a competitive advantage. Knowing in advance can also lead to simple ameliorative actions during convenient times (such as a player standing in front of a fan to cool off more for some downs when already off the field, and then returning to the game or practice) rather than the more serious actions that may be required (such as missing several series of downs, or the remainder of the game) when the player begins to exhibit symptoms of heat exhaustion.

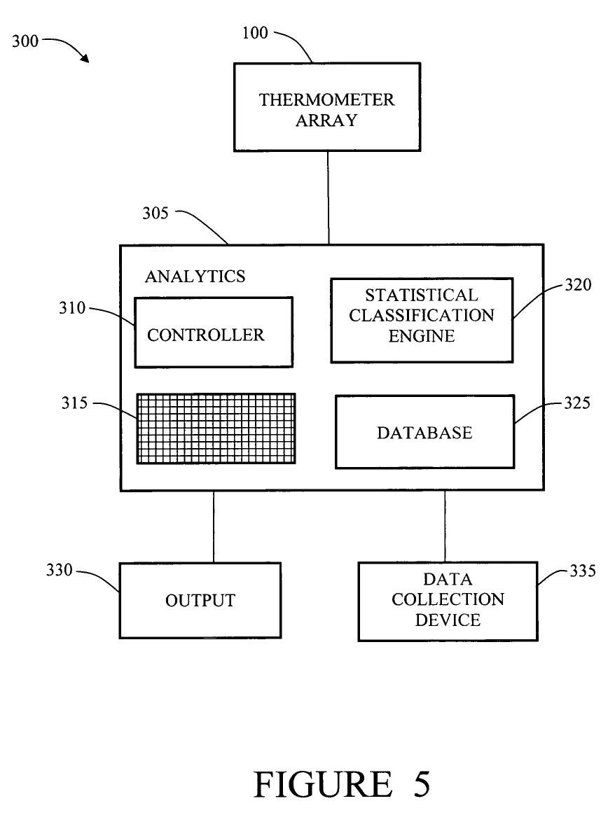

FIG. 5 is a block diagram of a core body temperature measuring system 300 according to one embodiment of the invention. The temperature system 300 includes a thermometer 100 as shown in FIG. 1. The temperature system 300 is connected to an analytics device 305. The analytics device 305 includes a controller 310 and a memory 315. The analytics device 305, which can be electronically located in the controller or elsewhere, collects the data from the thermometer 100 and performs an analysis on the temperature measurements of the plurality of sensors 105, 115, 125, 135. The results of the analysis are a core body temperature. In an alternative embodiment of the invention, the analytics device 305, which can be electronically located in the controller or elsewhere, further includes a statistical classification engine 320. The engine 320 includes a model or models into which the statistical classification engine 320 inputs temperature readings. The analytics device 305 is connected to an output device 330.

In a first embodiment of the temperature measuring system 300, the analytics device 305 and the output device 330 are integral to the thermometer 100. The output device 330 is for example a simple readout device such as an liquid crystal display (LCD). Alternatively, the output device 330 is a transmitter that transmits data to an external receiving device. Typically, the external receiving device has an associated display. In a further alternative embodiment, the analytics device 305 is not integral to the thermometer 100. In this embodiment, the thermometer 100 incorporates a transmitter capable of transmitting sensor data to the analytics device 305. In a still further alternative embodiment, the analytics device 305 communicates with a data collection device 335, which is typically not integral to the thermometer 100, and may be on the sideline or accessed through the Internet or by other means; however an integral data collection device or a data collection device 335 worn on the body of the person wearing the thermometer 100 is possible.

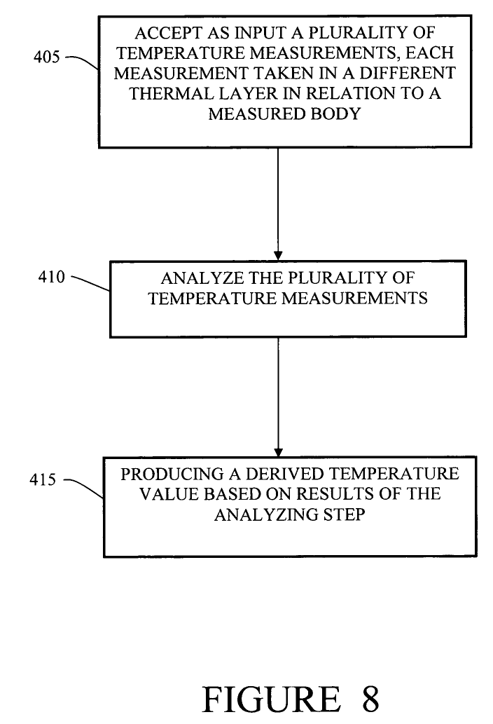

FIG. 8 is a flow chart showing a method of operating an analytics device associated with the layered thermometer according to one embodiment of the invention. At step 405, the analytics device accepts as input an array of two or more temperature measurements, that is, one measurement for each layer in the thermometer. The measurements in the temperature measurement array are typically taken substantially simultaneously. The measurements in the array are used to determine, through data analysis such as extrapolation, core body temperature. Alternatively, statistical learning techniques may be used to obtain core body temperature from the array measurements. In a further alternative embodiment of the invention, additional sensors such as thermal sensors, accelerometers and heat flux sensors are placed on the body. The additional sensors provide additional data used to determine core body temperature. In a further alternative embodiment, at least one additional sensor is placed in the ambient environment. The ambient temperature measurement is used to provide additional data used to determine core body temperature. In a still further alternative embodiment, an additional sensor on the body as well as at least one sensor in the surrounding environment is used in combination with the layered thermometer to acquire data to determine core body temperature. Further, those skilled in the art will understand that the present invention is not limited to the arrays described and shown herein. Other thermal arrays are contemplated within the scope of the invention.

At step 410, the analytics device analyzes the plurality of temperature measurements. In a first embodiment, the analytics device applies an extrapolation algorithm in order to obtain temperature values such as the core body temperature from the measured temperatures. In an alternative embodiment, the analytics device graphs the temperatures. In another alternative embodiment, the analytics device performs a statistical classification recognition as described above.

At step 415, the analytics device produces a derived temperature value based on the results of step 410. The analytics device at this step produces a derived temperature for a layer other than the layers measured in step 405, for example, a core body temperature. In a first embodiment, the derived core body temperature is a result of extrapolation from the temperature measurements taken in step 405 and analyzed in step 410. In a second embodiment, the derived core body temperature is a result of a prediction made from graphed data. In a third embodiment, the core body temperature is produced from a model determined through statistical analysis applied in step 410.

Using the analytics device as described above, data from the layered thermometer according to embodiments of the invention can be used to determine temperature at a layer outside of the layered thermometer such as core body temperature. As described above, in a first arrangement, the analytics device is integral to the thermometer. In another arrangement, the thermometer and the analytics device are separate devices that communicate wirelessly for example although a wired connection is possible for some applications.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A temperature device for measuring core body temperature, comprising:
a first layer to contact skin of a body being measured, the first layer including a first sensor and a first insulating component, the first layer to detect a first temperature substantially at the skin;
a second layer located contiguous to the first layer, the second layer including a second sensor and a second insulating component, the second layer to detect a second temperature substantially away from the skin; and
an analytic device to analyze data measured from each of the layers to determine core body temperature,
wherein the relationship between the first temperature and the second temperature indicates core temperature of the body.

2. The temperature device of claim 1 further comprising an intermediate layer interposed between the first layer and the second layer, the intermediate layer having an intermediate layer sensor and an intermediate layer insulating component.

3. The temperature device of claim 1 further comprising a protective layer positioned over the first layer and interposed between the skin and the first sensor.

4. The temperature device of claim 1 further comprising an output device to output the results of computation on the sensor data.

5. The temperature device of claim 4 wherein the output device is a readout device integral with the thermometer.

6. The temperature device of claim 4 wherein the output device is a transmitter to transmit to an external device.

7. The temperature device of claim 6 wherein the external device is an analytics device.

8. The temperature device of claim 1 wherein the analytics device further comprises a statistical classification engine and a database including data models to analyze thermal data.

9. The temperature device of claim 1 wherein the analytics device applies extrapolation to the data collected by the first and second sensors.

10. The temperature device of claim 1 wherein the analytics device applies statistical learning theory and pattern recognition to the data collected by the first and second sensors.

11. The temperature device of claim 1 further comprising an outer insulation layer.

12. The temperature device of claim 1 wherein the first layer and second layer and analytic device form an integral unit.

13. The temperature device of claim 1 wherein the layers form a layered thermometer and the analytic device is a separate unit apart from the layered thermometer.

14. A thermometer for measuring core body temperature, comprising:
a plurality of layers contiguously arranged, each layer including a sensor and an insulating component; and,
a first layer to be placed on the skin with the remaining plurality positioned at successive distances from the skin,
wherein a relationship of the temperatures of the layers indicates core body temperature.

15. A system for determining core body temperature, comprising:
a layered thermometer including a plurality of sensors, each sensor separated from neighboring sensors by layers of insulation;
an interface in communication with the layered thermometer; and
an analytics device in communication with the layered thermometer through the interface wherein the analytics device derives a core body temperature from sensor data.

16. The system of claim 15 wherein the analytics device applies extrapolation to the sensor data to produce the core body temperature.

17. The system of claim 15 wherein the analytics device applies statistical learning theory and pattern recognition to produce the core body temperature.

18. The system of claim 15 wherein the interface and the analytics device are integral to the layered thermometer.

19. The system of claim 15 further including an output device in communication with the analytics device.

20. The method of an analytics device in a system for measuring core body temperature, comprising:
accepting as input a plurality of temperature measurements, each measurement from a different thermal layer with relation to a measured body;
analyzing the plurality of temperature measurements; and
producing a derived temperature value based on results of the analyzing step.

21. The method of claim 20 wherein the analyzing step further comprises applying an extrapolation algorithm.

22. The method of claim 20 wherein the analyzing step further comprises performing a statistical classification analysis.
